(19) United States
(12) Patent Application Publication
(10) Pub. No.: US 2024/0363047 A1
(43) Pub. Date: Oct. 31, 2024

(54) DISPLAY PANEL AND DISPLAY DEVICE

(71) Applicant: Wuhan China Star Optoelectronics Technology Co., Ltd.

(72) Inventors: Mingyue LI, Wuhan, Hubei (CN); Chao TIAN, Wuhan, Hubei (CN); Fei AI, Wuhan, Hubei (CN)

(73) Assignee: Wuhan China Star Optoelectronics Technology Co., Ltd., Wuhan, Hubei (CN)

(21) Appl. No.: 18/038,717

(22) PCT Filed: Mar. 31, 2023
(86) PCT No.: PCT/CN2023/085651

§ 371 Date: May 25, 2023

(30) Foreign Application Priority Data
Mar. 28, 2023 (CN) 202310317472.9

(51) Int. Cl. G09G 3/20

(52) U.S. Cl. CPC G09G 3/20; G09G 2300/0408; G09G 2300/0426; G09G 2310/0283; G09G 2310/06

(57) ABSTRACT

A display panel and a display device are provided. Waveform adjustment modules with a higher distribution density are arranged in an area of a display area farther away from a gate driving circuit. This way, a problem of significant delays of scan signals in the display panel is improved, and the scan signals have the same or similar delays at different positions of the display area, which is advantageous for improving the display uniformity.

### TECHNICAL FIELD

The present application relates to a field of display technology and in particular, to a display panel and a display device.

### DESCRIPTION OF RELATED ART

With the rapid development of display technology, higher resolution has become an important direction for the development of display panels in order to provide customers with a more perfect life experience. However, as the resolution continues to increase, the delays of scan signals inside the display panel also become more serious.

### SUMMARY OF INVENTION

### Technical Problem

The present application provides a display panel and display device to alleviate technical problems of significant and uneven delays of end edges of scan signals in the display area.

### Technical Solution

In a first aspect, the present application provides a display panel. The display panel includes display area; a plurality of waveform adjustment modules disposed in the display area; and at least one gate driving circuit disposed on two sides of the display area; wherein a distribution density of the waveform adjustment modules in an area away from the gate driving circuit is greater than a distribution density of the waveform adjustment modules in an area close to the gate driving circuit.

In some embodiments, the display area includes a first display region and a second display region; an effective display width of the first display region is greater than an effective display width of the second display region; the first display region includes a plurality of first sub-areas; and the second display region includes a plurality of second sub-areas.

In some embodiments, two gate driving circuits are arranged on two sides of the display area respectively, and a width from left to right of the first display region is equal to a width from left to right of the second display region; and a distribution density of the waveform adjustment modules in the first sub-area farthest from the gate driving circuit is greater than a distribution density of the waveform adjustment modules in the second sub-area farthest from the gate driving circuit.

In some embodiments, two gate driving circuits are disposed on two sides of the first display region respectively, and one gate driving circuit is disposed on one of two sides of the second display region; and a distribution density of the waveform adjustment modules in the first sub-area farthest from the gate driving circuit is less than a distribution density of the waveform adjustment modules in the second sub-area farthest from the gate driving circuit.

In some embodiments, a first difference is a difference between a distribution density of the waveform adjustment modules in the first sub-area far away from the gate driving circuit and a distribution density of the waveform adjustment modules in the first sub-area close to the gate driving circuit; a second difference is a difference between a distribution density of the waveform adjustment modules in the second sub-area far away from the gate driving circuit and a distribution density of the waveform adjustment modules in the second sub-area close to the gate driving circuit; and the first difference is greater than the second difference.

In some embodiments, the display panel further includes a plurality of scan lines, a forward scanning control line, a reverse scanning control line, and a potential transmission line electrically connected to the waveform adjustment modules; the scan lines extend from the at least one gate driving circuit to the display area; and at least one of the forward scanning control line, the reverse scanning control line, or the potential transmission line extends into the display area from a non-display area which is arranged on a different side from a side where the gate driving circuit is disposed.

According to some embodiments, in a same width range, a distribution density of the waveform adjustment modules in the first sub-area is greater than a distribution density of the waveform adjustment modules in the second sub-area; the display panel further includes a forward scanning control supplementary line, a reverse scanning control supplementary line, and a potential transmission supplementary line electrically connected to the waveform adjustment modules; and at least one of the forward scanning control supplementary line, the reverse scanning control supplementary line, or the potential transmission supplementary line extends into the corresponding first sub-area from a non-display area which is on a different side from a side where the gate driving circuit is disposed and is close to the first display region.

According to some embodiments, in a same width range, a distribution density of the waveform adjustment modules in the first sub-area is less than a distribution density of the waveform adjustment modules in the second sub-area; the display panel further includes a forward scanning control supplementary line, a reverse scanning control supplementary line, and a potential transmission supplementary line electrically connected to the waveform adjustment modules; and at least one of the forward scanning control supplementary line, the reverse scanning control supplementary line, or the potential transmission supplementary line extends into the corresponding first sub-area from a non-display area which is on a different side from a side where the gate driving circuit is disposed and is close to the second display region.

In some embodiments, the second display region is arranged between the first display regions; in a same width range, a distribution density of the waveform adjustment modules in the first sub-area is less than a distribution density of the waveform adjustment modules in the second sub-area; the display panel further comprises a forward scanning control supplementary lines, a reverse scanning control supplementary line, and a potential transmission supplementary line electrically connected to the waveform adjustment modules; at least one of the forward scanning control supplementary line, the reverse scanning control supplementary line, or the potential transmission supplementary line extends into the corresponding second sub-area through the first display region from a non-display area which is on a different side from a side where the gate driving circuit is disposed and is close to the first display region; and at least one of the forward scanning control supplementary line, the reverse scanning control supplementary line, or the potential transmission supplementary line has fewer branches in the first display region than in the second display region.

In a second aspect, the present application provides a display device. The display device includes the display panel described in at least one of the above embodiments, wherein the waveform adjustment modules increase verticality of end edges of scan signals during a forward scanning process or a reverse scanning process.

### Advantages

The display panel and the display device provided by the present application alleviate the technical problem of significant delay of scan signals inside the display panel by providing in the display area a higher distribution density of the waveform adjustment modules in an area further away from the gate driving circuit. This not only alleviates a problem of significant delay of the scan signals in the display panel but also makes scan signals have the same or similar delays at different positions in the display area, which is beneficial to improve display uniformity.

### BRIEF DESCRIPTION OF DRAWINGS

FIG. 1 is a schematic diagram illustrating a first circuit structure of a display panel according to one embodiment of the present application.

FIG. 2 is a schematic circuit diagram of a waveform adjustment module in FIG. 1.

FIG. 3 is a schematic diagram illustrating a second circuit structure of the display panel according to one embodiment of the present application.

FIG. 4 is a schematic circuit diagram of a waveform adjustment module in FIG. 3.

FIG. 5 is a schematic comparison diagram illustrating a non-special-shaped display panel before and after improvement according to one embodiment of the present application.

FIG. 6 is a schematic diagram illustrating a first structure of a special-shaped display panel according to one embodiment of the present application.

FIG. 7 is a schematic diagram illustrating a second structure of the special-shaped display panel according to one embodiment of the present application.

FIG. 8 is a schematic diagram illustrating a third structure of the special-shaped display panel according to one embodiment of the present application.

FIG. 9 is a schematic diagram illustrating a fourth structure of the special-shaped display panel according to one embodiment of the present application.

FIG. 10 is a first distribution diagram illustrating waveform adjustment modules in the special-shaped display panel according to one embodiment of the present application.

FIG. 11 is a schematic diagram illustrating distribution of the waveform adjustment modules shown in FIG. 10.

FIG. 12 is a second distribution diagram illustrating the waveform adjustment modules in the special-shaped display panel according to one embodiment of the present application.

FIG. 13 is a schematic diagram illustrating distribution of the waveform adjustment modules shown in FIG. 12.

FIG. 14 is a third distribution diagram illustrating the waveform adjustment modules in the special-shaped display panel according to one embodiment of the present application.

FIG. 15 is a schematic diagram illustrating distribution of the waveform adjustment modules shown in FIG. 14.

FIG. 16 is a schematic diagram illustrating a third circuit structure of the display panel according to one embodiment of the present application.

FIG. 17 is a schematic diagram illustrating a fourth circuit structure of the display panel according to one embodiment of the present application.

FIG. 18 is a schematic diagram illustrating a fifth circuit structure of the display panel according to one embodiment of the present application.

### DETAILED DESCRIPTION OF EMBODIMENTS

In order to make the purpose, technical solutions and effects of the present application more clear, the present application is described in detail below with reference to the accompanying drawings and specific embodiments. It should be understood that the specific embodiments described here are only used to explain the present application, not to limit the present application.

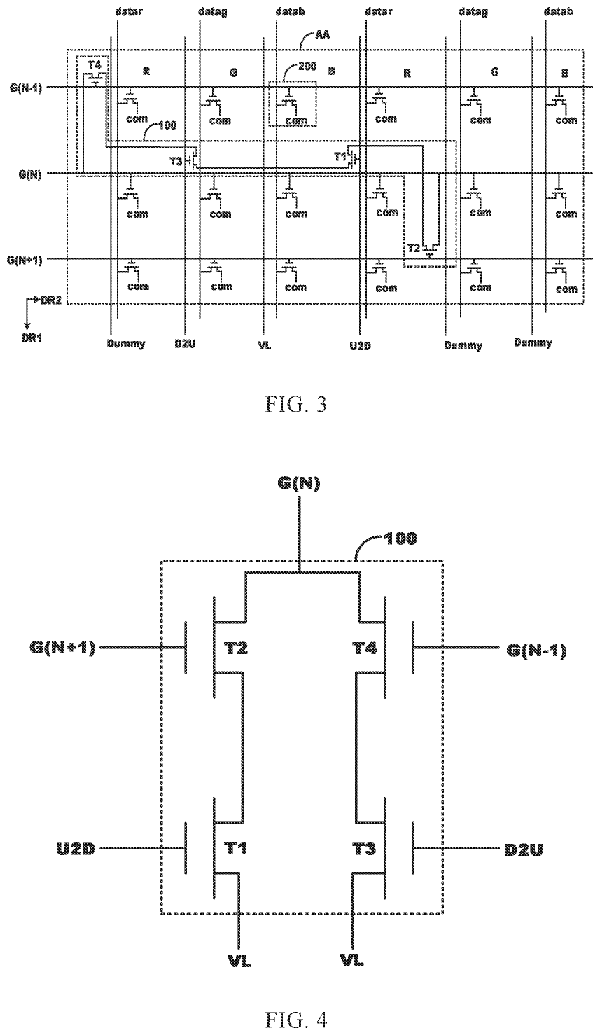

In order to solve a technical problem of significant delay of an end edge of a scan signal during a forward scanning process or a reverse scanning process, the present application provides a display panel. Please refer to FIGS. 1 to 15. As shown in FIG. 1 and FIG. 3, the display panel includes a plurality of scan lines sequentially arranged along a first direction DR1, a plurality of waveform adjustment modules 100, a potential transmission line VL, a forward scan control line U2D, and a reverse scan control line D2U. The multiple scan lines include an (N−1)-th scan line G(N−1), an N-th scan line G(N), and an (N+1)-th scan line G(N+1), where N is an integer greater than or equal to 2. An output terminal of the waveform adjustment module 100 is electrically connected to the (N+1)-th scan line G(N+1), and a first control terminal of the waveform adjustment module 100 is electrically connected to the (N−1)-th scan line G(N−1). A second control terminal of the waveform adjustment module 100 is electrically connected to the (N+1)-th scan line G(N+1). The waveform adjustment module 100 is located in a display area AA of the display panel. The potential transmission line VL is electrically connected to the first input terminal of the waveform adjustment module 100. The forward scan control line U2D is electrically connected to a second input terminal of the waveform adjustment module 100 or a third control terminal of the waveform adjustment module 100. The reverse scan control line D2U is electrically connected to a third input terminal of the waveform adjustment module 100 or a fourth control terminal of the waveform adjustment module 100.

It can be understood that, in the display panel of the present embodiment, the waveform adjustment module 100 is controlled by the (N−1)-th scan line G(N−1), the (N+1)-th scan line G(N+1), the potential transmission line VL, the forward scanning control line U2D, and the reverse scanning control line D2U, so that a duration of the end edge of the scan signal in the forward scanning process or the reverse scanning process is shortened, thereby alleviating a technical problem of significant delay of the scan signal in the display panel. This is conducive to improving the charging time of each pixel in the display panel or increasing a refresh rate of the display panel, which in turn facilitates the development of high-frequency and/or high-resolution displays.

Further, the display panel and the display device can alleviate the delay problem of the scan signal during the forward scanning process, and can also alleviate the delay problem of the scan signal during the reverse scanning process, thus providing greater flexibility for the assembly of the display panel.

It should be noted that the first direction DR1 is a direction in which the scan lines are aligned, and a second direction DR2 is a direction in which each of the scan lines extends.

The reverse scanning control line D2U, the potential transmission line VL, and the forward scanning control line U2D electrically connected to the same waveform adjustment module 100 can be arranged in sequence along the second direction DR2, which is beneficial to reduce transmission distances from the reverse scanning control line D2U, the potential transmission line VL, and the forward scanning control line U2D to the waveform adjustment module 100.

The display panel can further include a plurality of data lines sequentially arranged in the second direction DR2. The data lines include, for example, a first data line datar, a second data line datag, and a third data line datab. The scan lines intersect the data lines to form sub-pixels 200 arranged in an array. The first data line datar can be electrically connected to a column of red sub-pixels 200 (R). The second data line datag can be electrically connected to a column of green sub-pixels 200 (G). The third data line datab can be electrically connected to a column of the blue sub-pixels 200(B).

Specifically, the reverse scanning control line D2U is adjacent to and parallel to the first data line datar, and the reverse scanning control line D2U is located on a left side of the first data line datar. The potential transmission line VL is adjacent to and parallel to the second data line datag, and the potential transmission line VL is located on a left side of the second data line datag. The forward scanning control line U2D is adjacent to and parallel to the third data line datab, and the forward scanning control line U2D is located on a left side of the third data line datab. In this way, a loss of an aperture ratio of the pixel can be reduced. As shown in FIG. 3, if some data lines have no reverse scanning control lines D2U, potential transmission lines VL, and forward scanning control lines U2D arranged adjacent and parallel to the corresponding data lines and located on the left sides of the corresponding data lines, the display panel also has dummy lines adjacent and parallel to the corresponding data lines to balance the coupling effects of the data lines, so as to have consistent coupling effects on the data lines.

Each sub-pixel 200 can be a passive sub-pixel, such as a sub-pixel using a liquid crystal display technology. In this case, each sub-pixel 200 can include a thin film transistor. In the thin film transistor of each sub-pixel 200, one of a drain or a source of the thin film transistor is connected to the corresponding data line, the other one of the drain or the source of the thin film transistor is connected to a common voltage line con, and a gate of the thin film transistor is connected to the corresponding scan line.

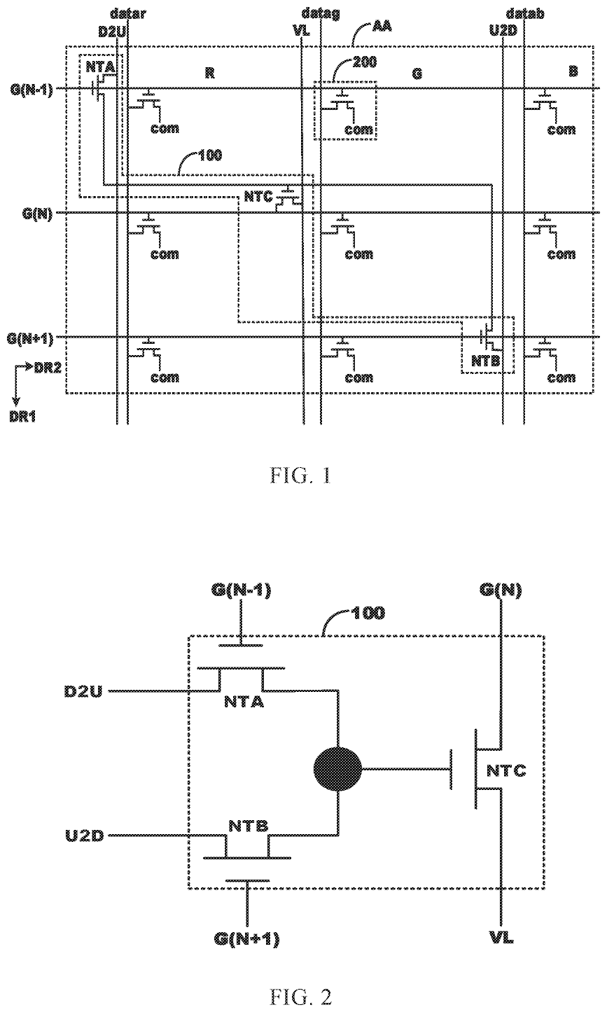

Referring to FIG. 2, in one of the embodiments, the waveform adjustment module 100 includes a first transistor NTA, a second transistor NTB, and a third transistor NTC. A first electrode of the first transistor NTA is electrically connected to the reverse scanning control line D2U, and a gate of the first transistor NTA is electrically connected to the (N−1)-th scan line G(N−1). A first electrode of the second transistor NTB is electrically connected to the forward scanning control line U2D, and a gate of the second transistor NTB is electrically connected to the (N+1)-th scan line G(N+1). A gate of the third transistor NTC is electrically connected to a second electrode of the first transistor NTA and a second electrode of the second transistor NTB, a first electrode of the third transistor NTC is electrically connected to the potential transmission line VL, and a second electrode of the third transistor NTC is electrically connected to the N-th scan line G(N).

It should be noted that the first electrode can be one of the source or the drain, and the second electrode can be the other one of the source or the drain. For example, when the first electrode is the source, the second electrode is the drain; or alternatively, when the first electrode is the drain, the second electrode is the source.

In the forward scanning process, when the (N+1)-th scanning line G(N+1) controls the second transistor NTB to be turned on, the forward scanning control line U2D controls the third transistor NTC to be turned on. A potential in the N-th scan line G(N) is adjusted to be a potential of the potential transmission line VL.

During the reverse scanning process, when the (N−1)-th scan line G(N−1) controls the first transistor NTA to be turned on, the reverse scanning control line D2U controls the third transistor NTC to be turned on. The potential of the N-th scan line G(N) is also adjusted to the potential of the potential transmission lines VL.

This way, verticality of an end edge of an N-th level scan signal in the N-th scan line G(N) can be improved during the forward scanning process, and the verticality of the end edge of the N-th level scan signal in the N-th scan line G(N) can be also improved during the reverse scanning process. The end edge refers to the falling edge for positive pulses and refers to the rising edge for negative pulses.

In one embodiment, the first transistor NTA, the second transistor NTB, and the third transistor NTC are all N-channel thin film transistors. The potential transmission line VL is used to transmit low-potential signals, and the low-potential signals are used to control the N-channel thin film transistors to be in an off state.

It should be noted that in this embodiment, when the scan signals transmitted in the scan lines have positive pulses, the positive pulse of each scan signal has a steeper or more vertical falling edge, so as to be closer to the ideal waveform of the pulse.

In one embodiment, both the first transistor NTA and the second transistor NTB are P-channel thin film transistors, and the third transistor NTC is an N-channel thin film transistor. The potential transmission line VL is used to transmit high potential signals, and the high potential signals are used to control the P-channel thin film transistor to be in an off state.

It should be noted that in this embodiment, when the scanning signals transmitted in each scanning line have negative pulses, the negative pulse of each scanning signal can have a steeper or more vertical rising edge, so as to be closer to the ideal waveform of the pulse.

In one embodiment, as shown in FIG. 4, the waveform adjustment module 100 includes a fourth transistor T1, a fifth transistor T2, a sixth transistor T3, and a seventh transistor T4. A first electrode of the fourth transistor T1 is electrically connected to the potential transmission line VL, and a gate of the fourth transistor T1 is electrically connected to the forward scanning control line U2D. A first electrode of the fifth transistor T2 is electrically connected to a second electrode of the fourth transistor T1, a gate of the fifth transistor T2 is electrically connected to the (N+1)-th scan line G(N+1), and a second electrode of the fifth transistor T2 is electrically connected to the N-th scan line G(N). A first electrode of the sixth transistor T3 is electrically connected to a first electrode of the fourth transistor T1, and a gate of the sixth transistor T3 is electrically connected to the reverse scanning control line D2U. A first electrode of the seventh transistor T4 is electrically connected to a second electrode of the sixth transistor T3, a gate of the seventh transistor T4 is electrically connected to the (N−1)-th scan line G(N−1), and a second electrode of the seventh transistor T4 is electrically connected to the N-th scan line G(N).

It should be noted that during the forward scanning process, the forward scanning line controls the fourth transistor T1 to be in an on state. When the (N+1)-th scan line G(N+1) controls the fifth transistor T2 to be turned on, a potential of the N-th scan line G(N) is adjusted to be a potential of the potential transmission line VL.

In the reverse scanning process, the reverse scanning line controls the sixth transistor T3 to be in an on state. When the (N−1)-th scan line G(N−1) controls the seventh transistor T4 to be turned on, the potential of the N-th scan line G(N) is adjusted to be the potential of the potential transmission line VL.

It can be understood that such configuration can not only improve the verticality of the end edge of the N-th scan signal in the N-th scan line G(N) during the forward scanning process, but also improve the verticality of the end edge of the N-th scan signal in the N-th scan line G(N) during the reverse scanning process.

In one embodiment, the fourth transistor T1, the fifth transistor T2, the sixth transistor T3, and the seventh transistor T4 are all N-channel thin film transistors. The potential transmission line VL is used to transmit low potential signals, and the low potential signals are used for controlling the N-channel thin film transistors to be in an off state.

It should be noted that in this embodiment, when the scan signals transmitted in the scan lines have positive pulses, the positive pulse of each scan signal has a steeper or more vertical falling edge, so as to be closer to the ideal waveform of the pulse.

In one embodiment, both the fourth transistor T1 and the sixth transistor T3 are N-channel thin film transistors, and both the fifth transistor T2 and the seventh transistor T4 are P-channel thin film transistors. The potential transmission line VL is used to transmit high potential signals, the high potential signals are used to control the P-channel thin film transistors to be in an off state.

It should be noted that in this embodiment, when the scan signals transmitted in the scan lines have negative pulses, the negative pulse of each scan signal has a steeper or more vertical rising edge, so as to be closer to the ideal waveform of the pulse.

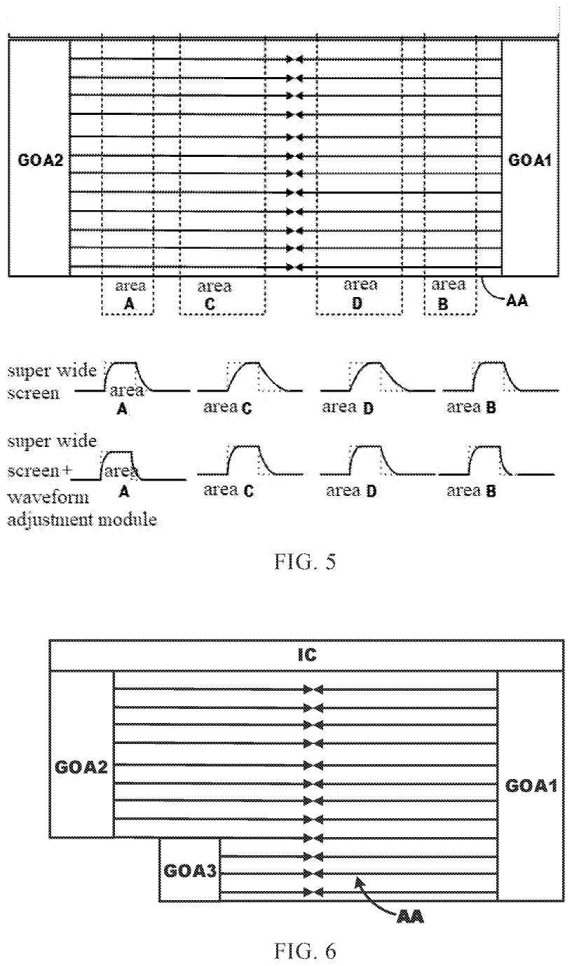

FIG. 5 is a schematic comparison diagram illustrating a non-special-shaped display panel before and after improvement according to one embodiment of the present application. The non-special-shaped display panel can be, but not limited to, a display panel with a rectangular display area AA. Specifically, the display area AA can be divided into four areas: an area A, an area B, an area C, and an area D. The area A and the area B are areas close to the second gate driving circuit GOA2 and the first gate driving circuit GOA1, respectively, and are symmetrically arranged about a center of the display area AA. The area C and the area D are areas located away from the second gate driving circuit GOA2 and the first gate driving circuit GOA1, respectively, and are symmetrically arranged about the center of the display area AA. In order to alleviate the delay problem of the end edge of the scan signal in the display area AA, a corresponding number of waveform adjustment modules 100 are respectively placed in each of the area A, area B, area C, and area D. One waveform adjustment module 100 is disposed for every M sub-pixels 200 in the area A and the area B, and one waveform adjustment module 100 is disposed for every N sub-pixels 200 in the area C and the area D, wherein M and N are integers, and M is less than or equal to N.

Before the waveform adjustment modules 100 are arranged in the display area AA, the falling edges of the corresponding scan signals in the areas A, B, C, and D are as shown in a row of waveforms designated by legends “super wide screen” in FIG. 5, which clearly shows that each falling edge has a greater delay.

After the waveform adjustment modules 100 are disposed in the display area AA, the falling edges of the corresponding scan signals in the areas A, B, C, and D are as shown in a row of waveforms designated by legends “super wide screen+waveform adjustment module” in FIG. 5, which clearly shows that each falling edge has a smaller delay, and each falling edge is also steeper or more vertical.

In the drawings, “IC” is a data driver or a data driving chip, which can provide corresponding data signals for each data line.

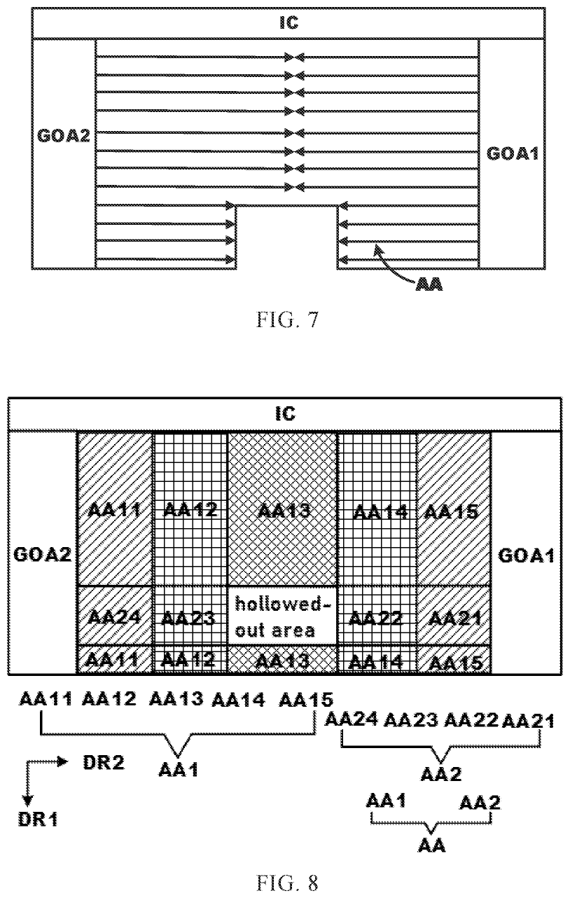

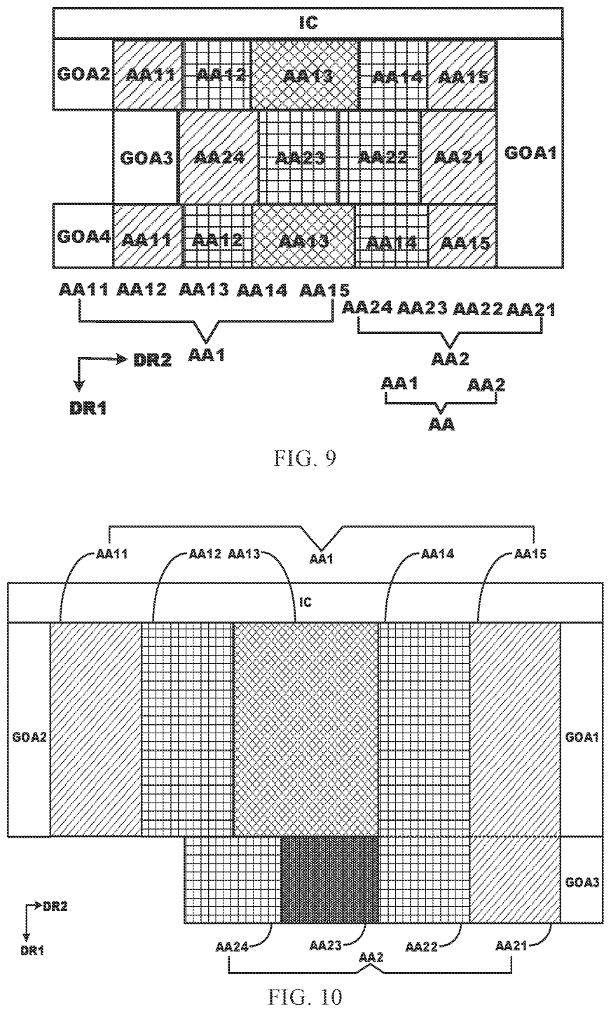

FIG. 6, FIG. 7, FIG. 8, and FIG. 9 respectively show a configuration of a special-shaped display panel. Compared with FIG. 5, the display area AA shown in any of FIGS. 6 to 9 is a non-rectangular area.

For example, a lower left corner of the display area AA shown in FIG. 6 is hollowed out. In this case, the first gate driving circuit GOA1 provides, from a right side, scan signals for the respective corresponding scan lines. The second gate driving circuit GOA2 provides, from a left side, scan signals for the respective corresponding scan lines which are arranged in a regular-shaped area of the display area AA. The third gate driving circuit GOA3 provides, from the left side, scan signals for the respective corresponding scan lines which are arranged corresponding to a special-shaped area of the display area AA.

In the display area AA shown in FIG. 7, a bottom edge area is hollowed out. In this case, the first gate driving circuit GOA1 provides, from a right side, scan signals for the respective corresponding scan lines, and the second gate driving circuit GOA2 provides, from a left side, scan signals for the respective corresponding scan signals.

In the display area AA shown in FIG. 8, a central area is hollowed out. In this case, the first gate driving circuit GOA1 provides, from a right side, corresponding scan signals for the respective corresponding scan lines, and the second gate driving circuit GOA2 provides, from a left side, scan signals for the respective corresponding scan lines.

In the display area AA shown in FIG. 9, a left edge area is hollowed out. In this case, the first gate driving circuit GOA1 provides, from a right side, scan signals for the respective corresponding scan lines. The second gate driving circuit GOA2 provides, from a left side, scan signals for the respective corresponding scan lines which are arranged in an upper part. The third gate driving circuit GOA3 provides, from the left side, scan signals for the respective corresponding scan lines arranged in a middle part. The fourth gate driving circuit GOA4 provides, from the left side, scan signals for the respective corresponding scan lines arranged in a lower part.

In one embodiment, as shown in FIGS. 8 to 15, the display panel includes the plurality of waveform adjustment modules 100 configured to improve the end edge of the scan signal in the display area AA. The first display region AA1 and the second display region AA2 are arranged in the first direction DR1. The second display region AA2 is located in a projection of the first display region AA1 projected in the first direction DR1, and the second display region AA2 covers the projection of the first display region AA1 projected in the first direction DR1.

The first gate driving circuit GOA1 and the second gate driving circuit GOA2 are arranged on two sides of the first display region AA1 respectively, and each scan line in the first display region AA1 is electrically connected to the first gate driving circuit GOA1 and the second gate driving circuit GOA2.

One or two of the first gate driving circuit GOA1, the second gate driving circuit GOA2, the third gate driving circuit GOA3, or the fourth gate driving circuit GOA4 are arranged on two sides of the second display region AA2. Each scan line in the second display region AA2 is electrically connected to one or two of the first gate driving circuit GOA1, the second gate driving circuit GOA2, the third gate driving circuit GOA3, or the fourth gate driving circuit GOA4.

The first display region AA1 includes a plurality of first display sub-areas arranged in sequence along the second direction DR2. A distribution density of the waveform adjustment modules 100 in each first display sub-area increases as the first display sub-area gets farther away from the first gate driving circuit GOA1 or the second gate driving circuit GOA2.

The second display region AA2 includes a plurality of second display sub-areas arranged in sequence along the second direction DR2. A distribution density of the waveform adjustment modules 100 in each second display region increases as the second display region gets farther away from one or two of the first gate driving circuit GOA1, the second gate driving circuit GOA2, the third gate driving circuit GOA3, and the fourth gate driving circuit GOA4.

It can be understood that, in the display panel of the present embodiment, by differentiate the distribution densities of the waveform adjustment modules 100 in the display regions that go with one of the gate driving circuit configurations, it can not only alleviate the significant delays of the scan signals in the display panel, but also make the scan signals have the same or similar delay at different positions of the display area AA, which is beneficial to improve the display uniformity.

It should be noted that the distribution density of the waveform adjustment modules 100 in each first display sub-area increases as the first display sub-area gets farther away from the first gate driving circuit GOA1 or the second gate driving circuit GOA2. The distribution density of the waveform adjustment modules 100 in each second display sub-area increases as the second display sub-area gets farther away from one or two of the first gate driving circuit GOA1, the second gate driving circuit GOA2, the third gate driving circuit GOA3, and the fourth gate driving circuit GOA4. Such a density arrangement for the waveform adjustment modules 100 is conducive to enabling the end edges of the scan signals to have the same delay at different positions in the display area AA, which in turn facilitates display uniformity of the display area AA.

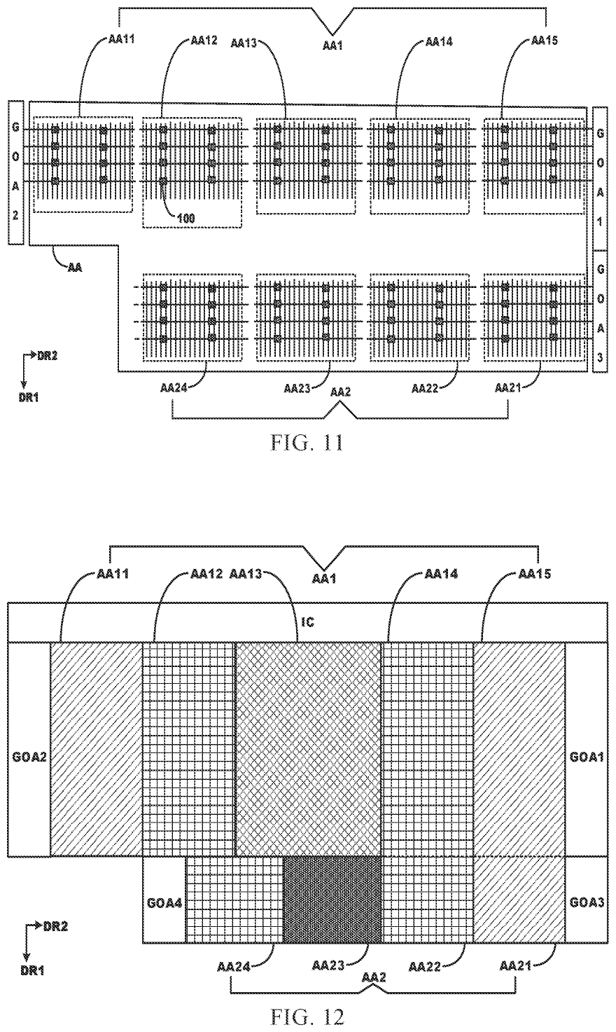

In one embodiment, as shown in FIG. 10 and FIG. 11, a first side of the first display region AA1 is aligned with a first side of the second display region AA2 in the first direction DR1. A second side of the first display region AA1 is not aligned with a second side of the second display region AA2 in the first direction DR1. The first side and the second side are respectively located on two sides of the display area AA in the second direction DR2.

The first gate driving circuit GOA1 is located on the second side of the first display region AA1, the second gate driving circuit GOA2 is located on the first side of the first display region AA1, and the third gate driving circuit GOA3 is located on the first side of the second display region AA2.

A first density change rate of the waveform adjustment modules 100 in the second display sub-areas is greater than a second density change rate. The second density change rate is a density change rate of the waveform adjustment modules 100 in the first display sub-areas.

It should be noted that the first display sub-areas can include a display sub-area AA11, a display sub-area AA12, a display sub-area AA13, a display sub-area AA14, a display sub-area AA15, and so on. The second display sub-areas can include a display sub-area AA21, a display sub-area AA22, a display sub-area AA23, a display sub-area AA24, and so on.

In the display sub-area AA11, the display sub-area AA15, and the display sub-area AA21, one waveform adjustment module 100 is disposed for every H sub-pixels 200. In the display sub-area AA12, the display sub-area AA14, and the display sub-area AA22, one waveform adjustment module 100 is disposed for every J sub-pixels 200. In the display sub-area AA13, one waveform adjustment module 100 is disposed for every K sub-pixels 200. Wherein, H, J, and K are all integers, and the values of H, J, and K decrease in sequence. In the display sub-area AA23, one waveform adjustment module 100 is provided for every K1 sub-pixels 200. In the display sub-area AA24, one waveform adjustment module 100 is provided for every J1 sub-pixels 200. Both J1 and K1 are integers, and J1 is greater than K1.

It can be understood that such a configuration can enable the end edges of the scan signals to have the same delay at different positions of the display area AA, which is beneficial to achieve display uniformity of the display area AA.

In other embodiments, K1 can also be greater than K, and J1 can also be greater than J. Such configuration can enable the end edges of the scan signals to have the same delay at different positions in the display area AA, which is beneficial to further achieve display uniformity of the display area AA.

In one embodiment, the first display sub-areas include a display sub-area AA11, a display sub-area AA12, a display sub-area AA13, a display sub-area AA14, and a display sub-area AA15 arranged in sequence in the second direction DR2. A width of the display sub-area AA11 in the second direction DR2 is equal to a width of the display sub-area AA15 in the second direction DR2. A distribution density of the waveform adjustment modules 100 in the display sub-area AA11 is the same as a distribution density of the waveform adjustment modules 100 in the display sub-area AA15. A width of the display sub-area AA12 in the second direction DR2 is equal to a width of the display sub-area AA14 in the second direction DR2. A distribution density of the waveform adjustment modules 100 in the display sub-area AA12 is equal to a distribution density of the waveform adjustment modules 100 in the display sub-area AA14. The distribution density of the waveform adjustment modules 100 in the display sub-area AA11, the distribution density of the waveform adjustment module 100 in the display sub-area AA12, and a distribution density of the adjustment modules 100 in the display sub-area AA13 increase sequentially.

In one embodiment, the second display sub-areas include the display sub-area AA24, the display sub-area AA23, the display sub-area AA22, and the display sub-area AA21 arranged in sequence in the second direction DR2. A distribution density of the waveform adjustment modules 100 in the display sub-area AA24, a distribution density of the waveform adjustment modules 100 in the display sub-area AA23, a distribution density of the waveform adjustment modules 100 in the display sub-area AA22, and a distribution density of the waveform adjustment modules 100 in the display sub-area AA21 decrease sequentially.

In one embodiment, a width of the display sub-area AA21 in the second direction DR2 is equal to the width of the display sub-area AA15 in the second direction DR2. The distribution density of the waveform adjustment modules 100 in the display sub-area AA21 is equal to the distribution density of the waveform adjustment modules 100 in the display sub-area AA15. A width of the display sub-area AA22 in the second direction DR2 is equal to the width of the display sub-area AA14 in the second direction DR2. The distribution density of the waveform adjustment modules 100 in the display sub-area AA22 is equal to the distribution density of the waveform adjustment modules 100 in the display sub-area AA14. A width of the display sub-area AA23 in the second direction DR2 is less than a width of the display sub-area AA13 in the second direction DR2. The distribution density of the waveform adjustment modules 100 in the display sub-area AA23 is greater than the distribution density of the waveform adjustment modules 100 in the display sub-area AA13. The distribution density of the waveform adjustment modules 100 in the display sub-area AA23 is less than the distribution density of the waveform adjustment modules 100 in the display sub-area AA24.

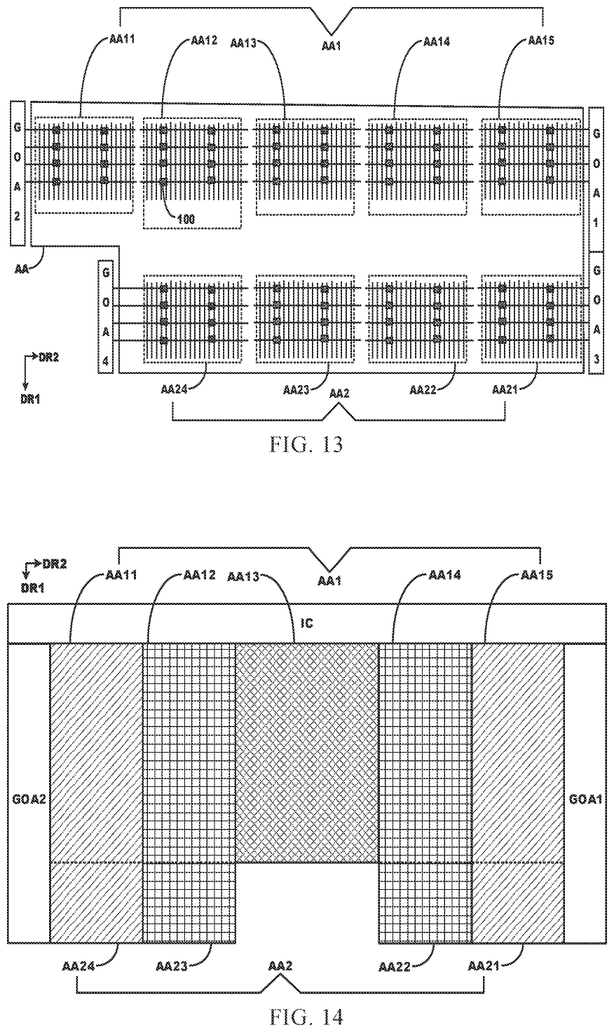

Referring to FIG. 12 and FIG. 13, in one embodiment, a first side of the first display region AA1 is aligned with a first side of the second display area AA2 in the first direction DR1. A second side of the first display region AA1 is not aligned with a second side of the second display area AA2 in the first direction DR1. The first side and the second side are respectively located on two sides of the display area AA in the second direction DR2.

The first gate driving circuit GOA1 is disposed on the first side of the first display region AA1, the second gate driving circuit GOA2 is disposed on the second side of the first display region AA1, the third gate driving circuit GOA3 is located on the first side of the second display region AA2, the fourth gate driving circuit GOA4 is disposed on the second side of the second display region AA2.

A first density change rate of the waveform adjustment modules 100 in the second display sub-areas is equal to a second density change rate. The second density change rate is a density change rate of the waveform adjustment modules 100 in the first display sub-areas.

It should be noted that, compared with FIG. 10 and FIG. 11, in this embodiment, the fourth gate driving circuit GOA4 is arranged on a left side of the second display region AA2. In this case, in the display sub-area AA11, the display sub-area the AA15, and the display sub-area AA21, one waveform adjustment module 100 is disposed for every H sub-pixels 200. Further, in the display sub-area AA12, the display sub-area AA14 and the display sub-area AA22, one waveform adjustment module 100 is disposed for every J sub-pixels 200. In the display sub-area AA13, one waveform adjustment module 100 is disposed for every K sub-pixels 200. Wherein, H, J, and K are all integers, and the values of H, J, K decrease in sequence. In the display sub-area AA23, one waveform adjustment module 100 is disposed for every K1 sub-pixels 200. In the display sub-area AA24, one waveform adjustment module 100 is disposed for every J1 sub-pixels 200. Wherein, J1 and K1 are both integers, and J1 is less than K1. Wherein, J1 can be greater than or equal to J, or J1 can be less than J. K1 can be greater than or equal to K, or K1 can be less than K.

It can be understood that such a configuration can enable the end edges of the scan signals to have the same delay at different positions of the display area AA, which is beneficial to achieve display uniformity of the display area AA.

In one embodiment, the first display sub-areas include a display sub-area AA11, a display sub-area AA12, a display sub-area AA13, a display sub-area AA14, and a display sub-area AA15 arranged in sequence in the second direction DR2. A width of the display sub-area AA11 in the second direction DR2 is equal to a width of the display sub-area AA15 in the second direction DR2. A distribution density of the waveform adjustment modules 100 in the display sub-area AA11 is the same as a distribution density of the waveform adjustment modules 100 in the display sub-area AA15. A width of the display sub-area AA12 in the second direction DR2 is equal to a width of the display sub-area AA14 in the second direction DR2. A distribution density of the waveform adjustment modules 100 in the display sub-area AA12 is equal to a distribution density of the waveform adjustment modules 100 in the display sub-area AA14. The distribution density of the waveform adjustment modules 100 in the display sub-area AA11, the distribution density of the waveform adjustment modules 100 in the display sub-area AA12, and the distribution density of the waveform adjustment modules 100 in the display sub-area AA13 increase sequentially. The second display sub-areas include a display sub-area AA24, a display sub-area AA23, a display sub-area AA22, and a display sub-area AA21 arranged in sequence in the second direction DR2. A width of the display sub-area AA24 in the second direction DR2 is equal to a width of the display sub-area AA21 in the second direction DR2. A distribution density of the waveform adjustment modules 100 in the display sub-area AA24 is equal to a distribution density of the waveform adjustment modules 100 in the display sub-area AA21. A width of the display sub-area AA23 in the second direction DR2 is equal to a width of the display sub-area AA22 in the second direction DR2. A distribution density of the waveform adjustment modules 100 in the display sub-area AA23 is the same as a distribution density of the waveform adjustment modules 100 in the display sub-area AA22. The distribution density of the waveform adjustment modules 100 in the display sub-area AA24 is less than the distribution density of the waveform adjustment modules 100 in the display sub-area AA23.

In one embodiment, the width of the display sub-area AA21 in the second direction DR2 is equal to the width of the display sub-area AA15 in the second direction DR2. The distribution density of the waveform adjustment modules 100 in the display sub-area AA21 is equal to the distribution density of the waveform adjustment modules 100 in the display sub-area AA15. The width of the display sub-area AA22 in the second direction DR2 is equal to the width of the display sub-area AA14 in the second direction DR2. The distribution density of the waveform adjustment modules 100 in the display sub-area AA22 is equal to the distribution density of the waveform adjustment modules 100 in the display sub-area AA14. The width of the display sub-area AA23 in the second direction DR2 is less than the width of the second display sub-area AA13 in the second direction DR2. The distribution density of the waveform adjustment modules 100 in the display sub-area AA23 is less than or equal to the distribution density of the waveform adjustment modules 100 in the display sub-area AA13. The distribution density of the waveform adjustment modules 100 in the display sub-area AA24 is greater than or equal to the distribution density of the waveform adjustment modules 100 in the display sub-area AA11, or alternatively, the distribution density of the waveform adjustment modules 100 in the display sub-area AA24 is less than the distribution density of the waveform adjustment modules 100 in the display sub-area AA11.

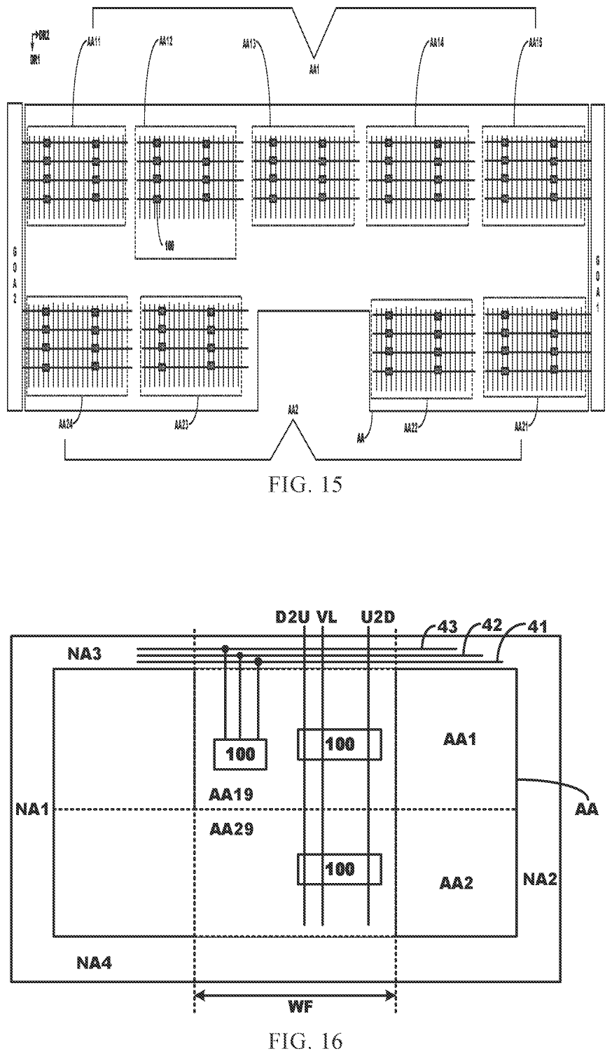

In one embodiment, as shown in FIG. 8, FIG. 14, and FIG. 15, a first side of the first display region AA1 is aligned with a first side of the second display region AA2 in the first direction DR1. A second side of the first display region AA1 is aligned with a second side of the second display region AA2 in the first direction DR1. The first side and the second side are respectively located on two sides of the display area AA in the second direction DR2. The second display region AA2 is located on one side of all the first display regions AA1 in the first direction DR1; or alternatively, the second display region AA2 is located between two first display regions AA1 in the first direction DR1.

The first gate driving circuit GOA1 is located on the first side of the display area AA. The second gate driving circuit GOA2 is located on the second side of the display area AA. Each scan line in the first display region AA1 is electrically connected to the first gate driving circuit GOA1 and the second gate driving circuit GOA2. Each scan line in the second display region AA2 is electrically connected to the first gate driving circuit GOA1 and the second gate driving circuit GOA2.

A first density change rate of the waveform adjustment modules 100 in the second display sub-areas is equal to a second density change rate. The second density change rate is a density change rate of the waveform adjustment modules 100 in the first display sub-areas.

In this embodiment, it should be noted that, in the display sub-area AA11, the display sub-area AA15, the display sub-area AA21, and the display sub-area AA24, one waveform adjustment module 100 is disposed for every H sub-pixels 200. In the display sub-area AA12, the display sub-area AA14, the display sub-area AA22, and the display sub-area AA23, one waveform adjustment module 100 is disposed for every J sub-pixels 200. In the third display sub-area AA13, one waveform adjustment module 100 is disposed for every K sub-pixels 200. Wherein, H, J, and K are all integers, and the values of H, J, and K decrease sequentially.

It can be understood that such a configuration can enable the end edges of the scan signals to have the same delay at different positions of the display area AA, which is beneficial to achieve display uniformity of the display area AA.

The first density change rate can be a ratio of the distribution density of the waveform adjustment modules 100 in the display sub-area AA12 to the distribution density of the waveform adjustment modules 100 in the display sub-area AA11, or the first density change rate can be a ratio of the distribution density of the waveform adjustment modules 100 in the display sub-area AA13 to the distribution density of the waveform adjustment modules 100 in the display sub-area AA12, or the first density change rate can be a ratio of the distribution density of the waveform adjustment modules 100 in the display sub-area CAA13 to the distribution density of the waveform adjustment modules 100 in the sub-area AA11. The second density change rate can be a ratio of the distribution density of the waveform adjustment modules 100 in the display sub-area AA22 to the distribution density of the waveform adjustment modules 100 in the display sub-area AA21, or the second density change rate can be a ratio of the distribution density of the waveform adjustment modules 100 in the display sub-area AA23 to the distribution density of the waveform adjustment modules 100 in the display sub-area AA22, or the second density change rate can be a ratio of the distribution density of the waveform adjustment modules 100 in the display sub-area AA24 to the density of the waveform adjustment modules 100 in the dry display sub-area AA23, or the second density change rate can be a ratio of the distribution density of the waveform adjustment modules 100 in the sub-area AA24 to the distribution density of the waveform adjustment modules 100 in the sub-area AA21.

It should be noted that the forward scanning control line U2D is configured to transmit a forward scan control signal. The forward scan control signal is used to control the display panel to perform a driving mode of forward scanning. Specifically, in the present application, the driving mode of forward scanning is performed under a condition that the forward scan control signal has a positive pulse. The reverse scan control line D2U is used to transmit a reverse scan control signal. The reverse scan control signal is used to control the display panel to perform a driving mode of reverse scanning. Specifically, in the present application, the driving mode of reverse scanning is performed under a condition that the reverse scan control signal has a positive pulse.

In one embodiment, the second display region AA2 is located on one side of all the first display regions AA1 in the first direction DR1. The first display sub-areas include a display sub-area AA11, a display sub-area AA12, a display sub-area AA13, a display sub-area AA14, and a display sub-area AA15 arranged in sequence in the second direction DR2. In the second display region AA2, there is a non-display area between a display sub-area AA23 and the display sub-area AA22. A width of the display sub-area AA11 in the second direction DR2 is equal to a width of the display sub-area AA15 in the second direction DR2. A distribution density of the waveform adjustment modules 100 in the display sub-area AA11 is equal to a distribution density of the waveform adjustment modules 100 in the display sub-area AA15. A width of the display sub-area AA12 in the second direction DR2 is equal to a width of the display sub-area AA14 in the second direction DR2. A distribution density of the waveform adjustment modules 100 in the display sub-area AA12 is the same as a distribution density of the waveform adjustment modules 100 in the display sub-area AA14. The distribution density of the waveform adjustment modules 100 in the display sub-area AA11, the distribution density of the waveform adjustment modules 100 in the display sub-area AA12, and a distribution density of the waveform adjustment modules 100 in the display sub-area AA13 increase sequentially. The second display sub-areas include a display sub-area AA24, the display sub-area AA23, the display sub-area AA22 and a display sub-area AA21 arranged in sequence in the second direction DR2. A width of the display sub-area AA24 in the second direction DR2, the width of the display sub-area AA11 in the second direction DR2, and a width of the display sub-area AA21 in the second direction DR2 are equal to each other. A distribution density of the waveform adjustment modules 100 in the display sub-area AA24, the distribution density of the waveform adjustment modules 100 in the first display sub-area AA11, and a distribution density of the waveform adjustment modules 100 in the display sub-area AA21 are equal to each other. A width of the display sub-area AA23 in the second direction DR2, the width of the second display sub-area AA12 in the second direction DR2, and a width of the ground display sub-area AA22 in the second direction DR2 are equal to each other. A distribution density of the waveform adjustment modules 100 in the display sub-area AA23, a distribution density of the waveform adjustment modules 100 in the display sub-area AA12, and a distribution density of the waveform adjustment module 100 in the ground display sub-area AA22 are equal to each other.

It should be noted that the non-display area in this embodiment is the hollowed-out area.

In one embodiment, the second display region AA2 is located between two first display regions AA1 in the first direction DR1. The first display sub-areas of each first display regions AA1 include a display sub-area AA11, a display sub-area AA12, a display sub-area AA13, a display sub-area AA14, and a display sub-area AA15. A width of the display sub-area AA11 in the second direction DR2 is equal to a width of the display sub-area AA15 in the second direction DR2. A distribution density of the waveform adjustment modules 100 in the display sub-area AA11 is equal to a distribution density of the waveform adjustment modules 100 in the display sub-area AA15. A width of the display sub-area AA12 in the second direction DR2 is equal to a width of the display sub-area AA14 in the second direction DR2. A distribution density of the waveform adjustment modules 100 in the display sub-area AA12 is equal to a distribution density of the waveform adjustment modules 100 in the display sub-area AA14. The distribution density of the waveform adjustment modules 100 in the display sub-area AA11, the distribution density of the waveform adjustment modules 100 in the display sub-area AA12, and a distribution density of the waveform adjustment modules 100 in the display sub-area AA13 increase sequentially. The second display sub-areas include a display sub-area AA24, a display sub-area AA23, a display sub-area AA22, and a display sub-area AA21 arranged in sequence in the second direction DR2. In the second display region AA2, there is a non-display area between the display sub-area AA23 and the display sub-area AA22. A width of the display sub-area AA24 in the second direction DR2, a width of the display sub-area AA11 in the second direction DR2, and a width of the display sub-area AA21 in the second direction DR2 are all equal to each other. A distribution density of the waveform adjustment modules 100 in the display sub-area AA24, a distribution density of the waveform adjustment modules 100 in the display sub-area AA11, and a distribution density of the waveform adjustment modules 100 in the display sub-area AA21 are all equal to each other. A width of the display sub-area AA23 in the second direction DR2, a width of the display sub-area AA12 in the second direction DR2, and a width of the display sub-area AA22 in the second direction DR2 are all equal to each other. A distribution density of the waveform adjustment modules 100 in the display sub-area AA23, a distribution density of the waveform adjustment modules 100 in the second display sub-area AA12, and a distribution density of the waveform adjustment modules 100 in the display sub-area AA22.

In one embodiment, the second display region AA2 is located between two first display sub-areas AA1 in the first direction DR1. A first side of each first display region AA1 is aligned with a first side of the second display region AA2 in the first direction DR1. A second side of the first display region AA1 and a second side of the second display region AA2 are not aligned in the first direction DR1. The first side and the second side are respectively located on two sides of the display area AA in the second direction DR2. The first gate driving circuit GOA1 is located on the first side of the display area AA, the second gate driving circuit GOA2 is located on the second side of the first display region AA1, the third gate driving circuit GOA3 is located on the second side of the second display region AA2, and the fourth gate driving circuit GOA4 is located on the second side of the other first display region AA1. Each scan line in one of the first display regions AA1 is electrically connected to the first gate driving circuit GOA1 and the second gate driving circuit GOA2. Each scan line in the second display region AA2 is electrically connected to the first gate driving circuit GOA1 and the third gate driving circuit GOA3. Each scan line in the other one of the first display regions AA1 is electrically connected to the first gate driving circuit GOA1 and the fourth gate driving circuit GOA4. In the second direction DR2, a distance from the second gate driving circuit GOA2 to the first gate driving circuit GOA1 is equal to a distance from the fourth gate driving circuit GOA4 to the first gate driving circuit GOA1. In the second direction DR2, the distance from the gate driving circuit GOA2 to the first gate driving circuit GOA1 is greater than a distance from the third gate driving circuit GOA3 to the first gate drive circuit GOA1. The first display sub-areas of each first display region AA1 include a display sub-area AA11, a display sub-area AA12, a display sub-area AA13, a display sub-area AA14, and a display sub-area AA15 arranged in sequence in the second direction DR2. A width of the display sub-area AA11 in the second direction DR2 is equal to a width of the display sub-area AA15 in the second direction DR2. A distribution density of the waveform adjustment modules 100 in the display sub-area AA11 is equal to a distribution density of the waveform adjustment modules 100 in the display sub-area AA15. A width of the display sub-area AA12 in the second direction DR2 is equal to a width of the display sub-area AA14 in the second direction DR2. A distribution density of the waveform adjustment modules 100 in the display sub-area AA12 is the same as a distribution density of the waveform adjustment modules 100 in the display sub-area AA14. The distribution density of the waveform adjustment modules 100 in the display sub-area AA11, the distribution density of the waveform adjustment modules 100 in the display sub-area AA12, and a distribution density of the waveform adjustment modules 100 in the display sub-area AA13 increase sequentially. The second display sub-areas include a display sub-area AA24, a display sub-area AA23, a display sub-area AA22, and a display sub-area AA21 arranged in sequence in the second direction DR2. A width of the display sub-area AA24 in the second direction DR2 is equal to a width of the display sub-region AA21 in the second direction DR2. A distribution density of the waveform adjustment modules 100 in the display sub-area AA24 is equal to a distribution density of the waveform adjustment modules 100 in the display sub-area AA21. A width of the display sub-area AA23 in the second direction DR2 is equal to a width of the display sub-area AA22 in the second direction DR2. A distribution density of the waveform adjustment modules 100 in the display sub-area AA23 is equal to a distribution density of the waveform adjustment modules 100 in the display sub-area AA22.

In one embodiment, the width of the display sub-area AA21 in the second direction DR2 is greater than the width of the display sub-area AA15 in the second direction DR2. The distribution density of the waveform adjustment modules 100 in the display sub-region AA21 is greater than the distribution density of the waveform adjustment modules 100 in the display sub-area AA15. The width of the display sub-area AA22 in the second direction DR2 is greater than the width of the display sub-area AA14 in the second direction DR2. The distribution density of the waveform adjustment modules 100 in the display sub-area AA22 is greater than the distribution density of the waveform adjustment modules 100 in the display sub-area AA14.

In one embodiment, a display device is provided. The display device includes the display panel of at least one of the above embodiments. Each scan line is used to transmit a corresponding scan signal. The waveform adjustment module 100 is used to increase the verticality of the end edge of the scan signal during the forward scanning process or the reverse scanning process.

It can be understood that, in the display device of the present embodiment, by differentiate the distribution densities of the waveform adjustment modules 100 in the display regions that go with one of the gate driving circuit configurations, it can not only alleviate the significant delays of the scan signals in the display panel, but also make the scan signals have the same or similar delay at different positions of the display area AA, which is beneficial to improve the display uniformity.

It can be understood that, the display device of the present embodiment includes the display panel of at least one of the above embodiments, the waveform adjustment module 100 is controlled by the (N−1)-th scan line G(N−1), the (N+1)-th scan line G(N+1), the potential transmission line VL, the forward scanning control line U2D, and the reverse scanning control line D2U, so that a duration of the end edge of the scan signal in the forward scanning process or the reverse scanning process is shortened, thereby alleviating a technical problem of significant delay of the scan signal in the display panel. This is conducive to improving a charging time of each pixel in the display panel or increasing a refresh rate of the display panel, which in turn facilitates the development of high-frequency and/or high-resolution displays.

Further, the display panel and the display device can alleviate the delay problem of the scan signal during the forward scanning process, and can also alleviate the delay problem of the scan signal during the reverse scanning process, thus providing greater flexibility for the assembly of the display panel.

It should be noted that the above-mentioned display panel can be a liquid crystal display panel, or a self-luminous display panel, such as an organic light-emitting diode display panel, a mini light-emitting diode display panel, a micro light-emitting diode display panel or a quantum dot light-emitting diode display panel.

Based on the above analysis, the present embodiment provides a display panel. Please refer to FIGS. 1 to 18. The display panel includes a plurality of waveform adjustment modules 100 in the display area AA. At least one gate driving circuit is arranged on two sides of the display area AA. A distribution density of the waveform adjustment modules 100 in an area away from the gate driving circuit is greater than a distribution density of the waveform adjustment modules 100 in an area close to the gate driving circuit.

It can be understood that, the display panel of the present embodiment alleviates the technical problem of significant delay of scan signals inside the display panel by providing in the display area AA a higher distribution density of the waveform adjustment modules in an area further away from the gate driving circuit. This not only alleviates a problem of significant delay of the scan signals in the display panel but also makes scan signals have the same or similar delays at different positions in the display area AA, which is beneficial to improve display uniformity.

It should be noted that each distribution density refers to a ratio of the number of the waveform adjustment modules 100 in one certain area to an area of this certain area.

In one embodiment, the display area AA includes a first display region AA1 and a second display region AA2. An effective display width of the first display region AA1 is greater than an effective display width of the second display region AA2. The first display region AA1 includes a plurality of first sub-areas AA19. The second display region AA2 includes a plurality of second sub-areas AA29.

It should be noted that the effective display width refers to a width of an area that can be used for display on the display panel. The first sub-area AA19 are used for display and arranged continuously in a direction of the effective display width. The second sub-areas AA29 can be arranged continuously or discontinuously in the direction of the effective display width.

The waveform adjustment modules 100 have the same distribution density in different areas in different first sub-areas AA19 or in different second sub-areas AA29. That is to say, the waveform adjustment modules 100 are evenly distributed in the first sub-areas AA19 or in the second sub-areas AA29.

In one embodiment, as shown in FIG. 8, two gate driving circuits are respectively disposed on two sides of the display area AA. A width from left to right of the first display region AA1 is equal to a width from left to right of the second display region AA2. A distribution density of the waveform adjustment modules 100 in the first sub-area AA19 farthest from the gate driving circuit is greater than a distribution density of the waveform adjustment modules 100 in the second sub-area AA29 farthest from the gate driving circuit.

It should be noted that a hollowed-out area in FIG. 8 can also be a second sub-area AA29. In this case, a distribution density of the waveform adjustment modules 100 in the hollowed-out area can be zero.

In one embodiment, as shown in FIG. 10 and FIG. 11, the first display region AA1 is provided with two gate driving circuits on two sides of the first display region AA1 respectively. The second display region AA2 is provided with only one gate driving circuit on one of the two sides of the second display region AA2. A distribution density of the waveform adjustment modules 100 in the first sub-area AA19 farthest from the gate driving circuit is less than a distribution density of the waveform adjustment modules 100 in the second sub-area AA29 farthest from the gate driving circuit.

It should be noted that the scan signal has a more serious delay in an area farther away from the gate driving circuit. Therefore, a higher distribution density of the waveform adjustment modules 100 can better adjust and correct the delay of the scan signal, the waveforms of the scan signals in the display area AA can be adjusted to be consistent.

In one embodiment, a first difference is a difference between a distribution density of the waveform adjustment modules 100 in the first sub-area AA19 away from the gate driving circuit and a distribution density in the first sub-area AA19 close to the gate driving circuit. A second difference is a difference between a distribution density of the waveform adjustment modules 100 in the second sub-area AA29 away from the gate driving circuit and a distribution density in the second sub-area AA29 close to the gate driving circuit. The first difference is greater than the second difference.

It should be noted that since the effective display width of the first display region AA1 is different from the effective display width of the second display region AA2. This embodiment can make the delays of the scan signals more consistent in the first display region AA1 and the second display region AA2, which is beneficial to improve display uniformity.

In one embodiment, as shown in FIG. 16 to FIG. 18, the display panel further includes a plurality of scan lines electrically connected to the waveform adjustment module 100, a forward scanning control line U2D, a reverse scanning control line D2U, and a potential transmission line VL. The scan lines extend from the gate driving circuit to the display area AA. At least one of the forward scanning control line U2D, the reverse scanning control line D2U, or the potential transmission line VL extends into the display area AA from the non-display area which is on a different side from a side where the gate driving circuit is disposed.

It should be noted that the non-display area can include at least one of a left border area NA1, a right border area NA2, an upper border area NA3, or a lower border area NA4. Each gate driving circuit can be located in the left border area NA1 and/or the border area. In this embodiment, at least one of the forward scanning control line U2D, the reverse scanning control line D2U, or the potential transmission line VL extends from the upper border area NA3 and/or the lower border area NA4 to the display area AA. Such configuration can avoid affecting an original arrangement of the scan lines. At least one of the forward scanning control line U2D, the reverse scanning control line D2U, or the potential transmission line VL can extend in the non-display area to be at least partially around the display area AA.

In one embodiment, as shown in FIG. 16, in a same width range WF, a distribution density of the waveform adjustment modules 100 in the first sub-area AA19 is greater than a distribution density of the waveform adjustment modules 100 in the second sub-area AA29. The display panel also includes a forward scanning control supplementary line 41, a reverse scanning control supplementary line 43, and a potential transmission supplementary line 42 electrically connected to the waveform adjustment modules 100. At least one of the forward scanning control supplementary lines 41, the reverse scanning control supplementary line 43, or the potential transmission supplementary line 42 extends into the corresponding first sub-area AA19 from the non-display area which is arranged on a different side from a side where the gate driving circuit is disposed and is close to the first display region AA1.

It should be noted that, when a distribution density of the waveform adjustment modules 100 in the first sub-area AA19 is sufficiently great so that the forward scanning control line U2D, the reverse scanning control line D2U, and the potential transmission line VL arranged with a fixed quantity in the display panel cannot meet the demand, it is required to add the forward scanning control supplementary line 41, the reverse scanning control supplementary line 43, and the potential transmission supplementary line 42 to make up for the problem of the insufficient number of the forward scanning control line U2D, the reverse scanning control line D2U, and the potential transmission line VL.

In this embodiment, the forward scanning control supplementary line 41, the reverse scanning control supplementary line 43, and the potential transmission supplementary line 42 can extend from the upper border area NA3 to the corresponding first sub-area AA19, which reduces the transmission paths of corresponding signals and does not affect the second display region AA2.

In one embodiment, as shown in FIG. 17, in the same width range WF, a distribution density of the waveform adjustment modules 100 in the first sub-area AA19 is less than a distribution density of the waveform adjustment modules 100 in the second sub-area AA29. The display panel also includes the forward scanning control supplementary line 41, the reverse scanning control supplementary line 43, and the potential transmission supplementary line 42 electrically connected to the waveform adjustment modules 100. At least one of the forward scanning control supplementary line 41, the reverse scanning control supplementary line 43, or the potential transmission supplementary line 42 extends into the corresponding first sub-area AA19 from the non-display area which is on a different side from a side where the gate driving circuit is disposed and is close to the second display region AA2.

It should be noted that, when a distribution density of the waveform adjustment modules 100 in the second sub-area AA29 is sufficiently great so that the forward scanning control line U2D, the reverse scanning control line D2U and the potential transmission line VL arranged with a fixed quantity in the display panel cannot meet the demand, it is required to add the forward scanning control supplementary line 41, the reverse scanning control supplementary line 43, and the potential transmission supplementary line 42 to make up for the problem of insufficient number of the forward scanning control line U2D, the reverse scanning control line D2U, and the potential transmission line VL.

In this embodiment, the forward scanning control supplementary line 41, the reverse scanning control supplementary line 43, and the potential transmission supplementary line 42 can extend from the lower border area NA3 to the corresponding second sub-area AA29, which reduces the transmission paths of corresponding signals and does not affect the first display region AA2.

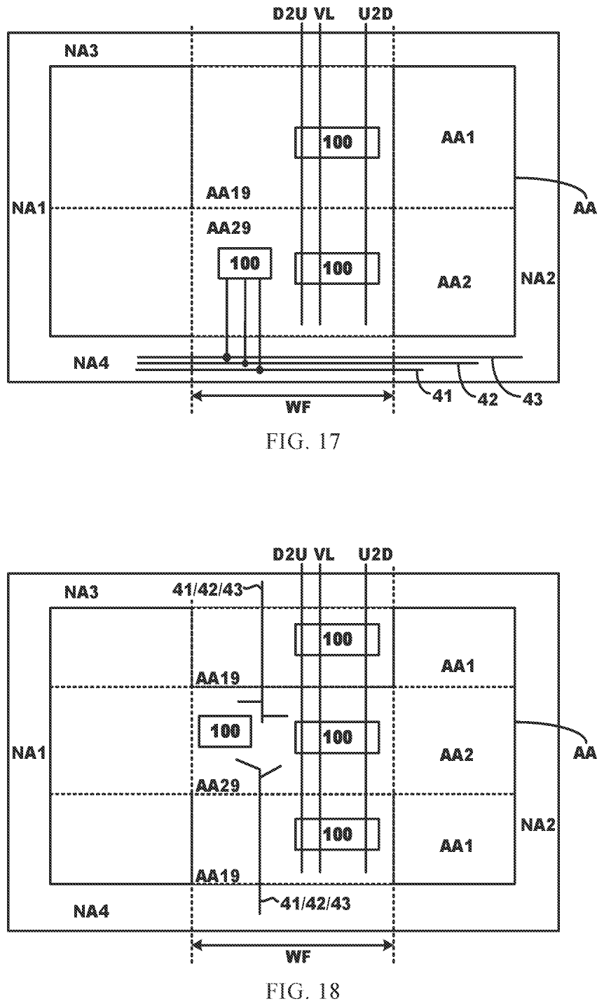

In one embodiment, as shown in FIG. 9 and FIG. 18, the second display region AA2 is located between two first display regions AA1. In the same width range WF, a distribution density of the waveform adjustment modules 100 in the first sub-area AA19 is less than a distribution density of the waveform adjustment modules 100 in the second sub-area AA29. The display panel also includes the forward scanning control supplementary line 41, the reverse scanning control supplementary line 43, and the potential transmission supplementary line 42 electrically connected to the waveform adjustment modules 100. At least one of the forward scanning control supplementary line 41, the reverse scanning control supplementary line 43, or the potential transmission supplementary line 42 extends to the corresponding second sub-area AA29 through the first display region AA1 from the non-display area which is on a different side from a side where the gate drive circuit is disposed and close to the first display region AA1. At least one of the forward scanning control supplementary line 41, the reverse scanning control supplementary line 43, or the potential transmission supplementary line 42 has less branches in the first display area AA1 than in the second display area AA2.

It should be noted that, when the distribution density of the waveform adjustment modules 100 in the second sub-area AA29 is sufficiently large so that the forward scanning control line U2D, the reverse scanning control line D2U, and the potential transmission line VL arranged with a fixed quantity in the display panel cannot meet the demand, it is required to add the forward scanning control supplementary line 41, the reverse scanning control supplementary line 43, and the potential transmission supplementary line 42 to make up for the problem of insufficient number of the forward scanning control line U2D, the reverse scanning control line D2U, and the potential transmission line VL.

However, since it is inconvenient to extend the forward scanning control supplementary line 41, the reverse scan control supplementary line 43, and the potential transmission supplementary line 42 into the second display region AA2 from the left border area NA1 and/or the right border area NA2. Therefore, the forward scanning control supplementary line 41, the reverse scan control supplementary line 43, and the potential transmission supplementary line 42 need to extend into the corresponding second sub-area AA29 through the first display region AA1 from the upper border area NA3 and/or the lower border area NA4. In this embodiment, the forward scanning control supplementary line 41/the reverse scanning control supplementary line 43/the potential transmission supplementary line 42 which has one line in the first display region AA1 is divided into multiple branches in the second display region AA2. This can minimize the influence on the first display region AA1 and also satisfy the needs of the corresponding second sub-area AA29.

In another embodiment, different waveform adjustment modules 100 in the second sub-area AA29 can share at least one of the forward scanning control line U2D, the reverse scanning control line D2U, or the potential transmission line VL. Such configuration can also satisfy the needs of the waveform adjustment modules 100.

It should be noted that the display panel shown in FIG. 16 to FIG. 18 can have a rectangular display screen or can be any of a variety of special-shaped screens. For example, the above-mentioned display screen with a hollowed-out area or a missing corner.

It can be understood that those skilled in the art can make equivalent replacements or changes according to the technical solutions and inventive concepts of the present application. Such changes or replacements should be deemed to fall within the protection scope defined by the appended claims of the present application.

What is claimed is:

1. A display panel, comprising:
a display area;
a plurality of waveform adjustment modules disposed in the display area; and
at least one gate driving circuit disposed on two sides of the display area;
wherein a distribution density of the waveform adjustment modules in an area away from the gate driving circuit is greater than a distribution density of the waveform adjustment modules in an area close to the gate driving circuit.

2. The display panel according to claim 1, wherein the display area comprises a first display region and a second display region; an effective display width of the first display region is greater than an effective display width of the second display region; the first display region comprises a plurality of first sub-areas; and the second display region comprises a plurality of second sub-areas.

3. The display panel according to claim 2, wherein two gate driving circuits are arranged on two sides of the display area respectively, and a width from left to right of the first display region is equal to a width from left to right of the second display region; and
a distribution density of the waveform adjustment modules in the first sub-area farthest from the gate driving circuit is greater than a distribution density of the waveform adjustment modules in the second sub-area farthest from the gate driving circuit.

4. The display panel according to claim 2, wherein two gate driving circuits are disposed on two sides of the first display region respectively, and one gate driving circuit is disposed on one of two sides of the second display region; and
a distribution density of the waveform adjustment modules in the first sub-area farthest from the gate driving circuit is less than a distribution density of the waveform adjustment modules in the second sub-area farthest from the gate driving circuit.

5. The display panel according to claim 2, wherein a first difference is a difference between a distribution density of the waveform adjustment modules in the first sub-area far away from the gate driving circuit and a distribution density of the waveform adjustment modules in the first sub-area close to the gate driving circuit; a second difference is a difference between a distribution density of the waveform adjustment modules in the second sub-area far away from the gate driving circuit and a distribution density of the waveform adjustment modules in the second sub-area close to the gate driving circuit; and the first difference is greater than the second difference.

6. The display panel according to claim 2, further comprising a plurality of scan lines, a forward scanning control line, a reverse scanning control line, and a potential transmission line electrically connected to the waveform adjustment modules, wherein the scan lines extend from the at least one gate driving circuit to the display area; and at least one of the forward scanning control line, the reverse scanning control line, or the potential transmission line extends into the display area from a non-display area which is arranged on a different side from a side where the gate driving circuit is disposed.

7. The display panel according to claim 6, wherein in a same width range, a distribution density of the waveform adjustment modules in the first sub-area is greater than a distribution density of the waveform adjustment modules in the second sub-area; the display panel further comprises a forward scanning control supplementary line, a reverse scanning control supplementary line, and a potential transmission supplementary line electrically connected to the waveform adjustment modules; and at least one of the forward scanning control supplementary line, the reverse scanning control supplementary line, or the potential transmission supplementary line extends into the corresponding first sub-area from a non-display area which is on a different side from a side where the gate driving circuit is disposed and is close to the first display region.

8. The display panel according to claim 6, wherein in a same width range, a distribution density of the waveform adjustment modules in the first sub-area is less than a distribution density of the waveform adjustment modules in the second sub-area; the display panel further comprises a forward scanning control supplementary line, a reverse scanning control supplementary line, and a potential transmission supplementary line electrically connected to the waveform adjustment modules; and at least one of the forward scanning control supplementary line, the reverse scanning control supplementary line, or the potential transmission supplementary line extends into the corresponding first sub-area from a non-display area which is on a different side from a side where the gate driving circuit is disposed and is close to the second display region.

9. The display panel according to claim 6, wherein the second display region is arranged between the first display regions; in a same width range, a distribution density of the waveform adjustment modules in the first sub-area is less than a distribution density of the waveform adjustment modules in the second sub-area; the display panel further comprises a forward scanning control supplementary lines, a reverse scanning control supplementary line, and a potential transmission supplementary line electrically connected to the waveform adjustment modules; at least one of the forward scanning control supplementary line, the reverse scanning control supplementary line, or the potential transmission supplementary line extends into the corresponding second sub-area through the first display region from a non-display area which is on a different side from a side where the gate driving circuit is disposed and is close to the first display region; and at least one of the forward scanning control supplementary line, the reverse scanning control supplementary line, or the potential transmission supplementary line has fewer branches in the first display region than in the second display region.

10. A display device, comprising the display panel of claim 1, wherein the waveform adjustment modules increase verticality of end edges of scan signals during a forward scanning process or a reverse scanning process.

11. The display device according to claim 10, wherein the display area comprises a first display region and a second display region; an effective display width of the first display region is greater than an effective display width of the second display region; the first display region comprises a plurality of first sub-areas; and the second display region comprises a plurality of second sub-areas.

12. The display device according to claim 11, wherein two gate driving circuits are arranged on two sides of the display area respectively, and a width from left to right of the first display region is equal to a width from left to right of the second display region; and
a distribution density of the waveform adjustment modules in the first sub-area farthest from the gate driving circuit is greater than a distribution density of the waveform adjustment modules in the second sub-area farthest from the gate driving circuit.

13. The display device according to claim 11, wherein two gate driving circuits are disposed on two sides of the first display region respectively, and one gate driving circuit is disposed on one of two sides of the second display region; and
a distribution density of the waveform adjustment modules in the first sub-area farthest from the gate driving circuit is less than a distribution density of the waveform adjustment modules in the second sub-area farthest from the gate driving circuit.

14. The display device according to claim 11, wherein a first difference is a difference between a distribution density of the waveform adjustment modules in the first sub-area far away from the gate driving circuit and a distribution density of the waveform adjustment modules in the first sub-area close to the gate driving circuit; a second difference is a difference between a distribution density of the waveform adjustment modules in the second sub-area far away from the gate driving circuit and a distribution density of the waveform adjustment modules in the second sub-area close to the gate driving circuit; and the first difference is greater than the second difference.

15. The display device according to claim 11, further comprising a plurality of scan lines, a forward scanning control line, a reverse scanning control line, and a potential transmission line electrically connected to the waveform adjustment modules, wherein the scan lines extend from the at least one gate driving circuit to the display area; and at least one of the forward scanning control line, the reverse scanning control line, or the potential transmission line extends into the display area from a non-display area which is arranged on a different side from a side where the gate driving circuit is disposed.

16. The display device according to claim 15, wherein in a same width range, a distribution density of the waveform adjustment modules in the first sub-area is greater than a distribution density of the waveform adjustment modules in the second sub-area; the display panel further comprises a forward scanning control supplementary line, a reverse scanning control supplementary line, and a potential transmission supplementary line electrically connected to the waveform adjustment modules; and at least one of the forward scanning control supplementary line, the reverse scanning control supplementary line, or the potential transmission supplementary line extends into the corresponding first sub-area from a non-display area which is on a different side from a side where the gate driving circuit is disposed and is close to the first display region.

17. The display device according to claim 15, wherein in a same width range, a distribution density of the waveform adjustment modules in the first sub-area is less than a distribution density of the waveform adjustment modules in the second sub-area; the display panel further comprises a forward scanning control supplementary line, a reverse scanning control supplementary line, and a potential transmission supplementary line electrically connected to the waveform adjustment modules; and at least one of the forward scanning control supplementary line, the reverse scanning control supplementary line, or the potential transmission supplementary line extends into the corresponding first sub-area from a non-display area which is on a different side from a side where the gate driving circuit is disposed and is close to the second display region.

18. The display device according to claim 15, wherein the second display region is arranged between the first display regions; in a same width range, a distribution density of the waveform adjustment modules in the first sub-area is less than a distribution density of the waveform adjustment modules in the second sub-area; the display panel further comprises a forward scanning control supplementary lines, a reverse scanning control supplementary line, and a potential transmission supplementary line electrically connected to the waveform adjustment modules; at least one of the forward scanning control supplementary line, the reverse scanning control supplementary line, or the potential transmission supplementary line extends into the corresponding second sub-area through the first display region from a non-display area which is on a different side from a side where the gate driving circuit is disposed and is close to the first display region; and at least one of the forward scanning control supplementary line, the reverse scanning control supplementary line, or the potential transmission supplementary line has fewer branches in the first display region than in the second display region.

19. The display device according to claim 10, wherein each of the waveform adjustment modules comprises a first transistor, a second transistor, and a third transistor; a first electrode of the first transistor is electrically connected to a reverse scanning control line, and a gate of the first transistor is electrically connected to an (N−1)-th scan line; a first electrode of the second transistor is electrically connected to the forward scanning control line, and a gate of the second transistor is electrically connected to an (N+1)-th scan line; a gate of the third transistor is electrically connected to a second electrode of the first transistor and a second electrode of the second transistor; and a first electrode of the third transistor is electrically connected to a potential transmission line, and a second electrode of the third transistor is electrically connected to an N-th scan line.

20. The display device according to claim 10, wherein each of the waveform adjustment modules comprises a fourth transistor, a fifth transistor, a sixth transistor, and a seventh transistor; a first electrode of the fourth transistor is electrically connected to a potential transmission line, and a gate of the fourth transistor is electrically connected to a forward scanning control line; a first electrode of the fifth transistor is electrically connected to a second electrode of the fourth transistor, a gate of the fifth transistor is electrically connected to an (N+1)-th scan line, and a second electrode of the fifth transistor is electrically connected to an N-th scan line; a first electrode of the sixth transistor is electrically connected to a first electrode of the fourth transistor, and a gate of the sixth transistor is electrically connected to a reverse scanning control line; and a first electrode of the seventh transistor is electrically connected to a second electrode of the sixth transistor, a gate of the seventh transistor is electrically connected to an (N−1)-th scan line, and a second electrode of the seventh transistor is electrically connected to the N-th scan line.
